(19) United States
(12) Patent Application Publication
(10) Pub. No.: US 2017/0089827 A1
(43) Pub. Date: Mar. 30, 2017

(54) CORROSION SENSOR FOR HEAT EXCHANGERS

(71) Applicant: Carrier Corporation, Farmington, CT (US)

(72) Inventor: Hongbo Ding, Manlius, NY (US)

(21) Appl. No.: 15/126,914

(22) PCT Filed: Mar. 10, 2015
(86) PCT No.: PCT/US2015/019645

§ 371 Date: Sep. 16, 2016

Related U.S. Application Data
(60) Provisional application No. 61/954,891, filed on Mar. 18, 2014.

(51) Int. Cl. G01N 17/02

(52) U.S. Cl. CPC G01N 17/02

(57) ABSTRACT

Embodiments are directed to an installation of a first tube made of a first material on a heat exchanger that is different from a second material associated with a second tube of the heat exchanger. The first tube is coupled to the second tube via a porous layer associated with the first tube. A signal is measured between the first tube and the second tube. The measured signal is logged as data. Information associated with a corrosiveness of an environment in which the heat exchanger is located is obtained based on the data.

### BACKGROUND

Corrosion can cause a leaking of heat exchangers (HXs) in heating, ventilation, and air conditioning (HVAC) systems. A sensor device that can detect the corrosive environment of the HXs is critical for maintenance and for development of new HXs. Conventional sensors are not designed for HXs and are therefore not able to correctly sense the HXs' corrosive environment. For example, wire-on-bolt sensors used for characterizing corrosive environments are not able to give the critical information associated with leaking (i.e., pitting corrosion of HXs) but just provide the general corrosivity of the environment. In addition, some commercial sensors are expensive due to their utilization of sophisticated electronics.

A leaking of HX coil can cause an HVAC system to become inoperative. In the context of container evaporators, the main cause of leaking may be due to corrosion of one or more tubes. The issue may be even more pronounced for tubes incorporating some materials (e.g., aluminum) relative to other materials (e.g., copper). If the HX leaks, cargo located in an environment controlled by the HX can be compromised or subject to spoliation.

### BRIEF SUMMARY

An embodiment is directed to a method comprising: installing a first tube made of a first material on a heat exchanger that is different from a second material associated with a second tube of the heat exchanger, wherein the first tube is coupled to the second tube via a porous layer associated with the first tube, measuring a signal between the first tube and the second tube, logging the measured signal as data, and obtaining information associated with a corrosiveness of an environment in which the heat exchanger is located based on the data.

An embodiment is directed to a corrosion sensor, comprising: a first tube made of a first material, a second tube made of a second material that is different from the first material, and a porous layer associated with the first tube configured to couple the first tube and the second tube.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a block diagram of a system incorporating a heat exchanger in accordance with one or more embodiments;

FIG. 2 illustrates a chart demonstrating a measurement of a potential difference between materials in accordance with one or more embodiments;

FIG. 3 is a plot of voltage versus time for a specimen inserted into a corrosion chamber in accordance with one or more embodiments; and

FIG. 4 is a flow chart of an exemplary method in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

In some embodiments, a section of a heat exchanger (HX) coil may be used as a sensor unit. By doing so, the sensor is able to provide specific information regarding the actual HX, such as time-of-wetness at the coil tube surfaces (e.g., tube/fin interface). The pitting corrosion of the tubes (leaking threat) may be monitored and correlated to the sensor signal, which may be a current or voltage. The sensor signal may be recorded simply through a cheap and re-usable data logger.

In some embodiments, a sensor may be a unit that is independent of a HX. The sensor may be fabricated by sectioning a small unit from an actual HX coil.

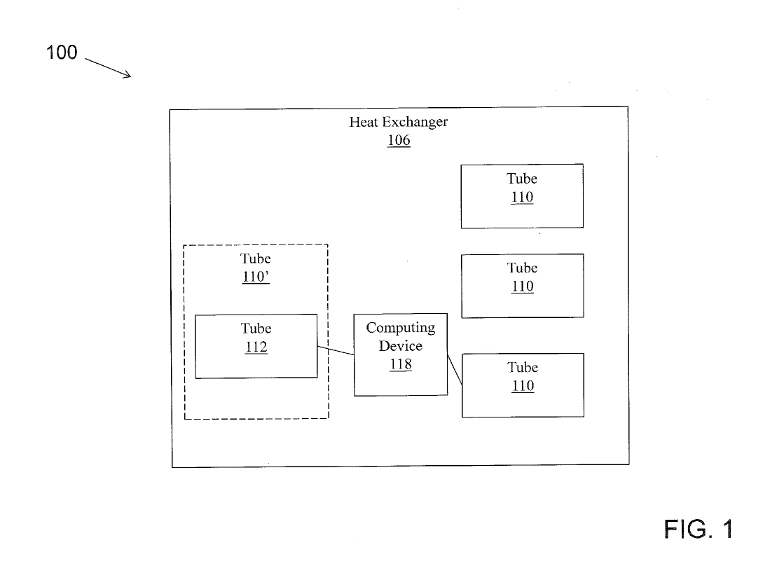

Referring to FIG. 1, a system 100 is shown. The system 100 may include a HX 106. The HX 106 may include a number of tubes 110 and fins (not shown) as would be known to one of skill in the art. The tubes 110 and fins may be made of one or more materials, such as aluminum.

In order to provide for a corrosion detection sensor, one of the tubes 110 may be removed from the HX 106. As an example, a tube 110′ may be removed from the HX 106. In place of the tube 110′, a tube 112 may be installed or inserted in the HX 106.

The tube 112 may be of a different material than the tubes 110 or the structure of the HX 106. In an embodiment, the tube 112 may be made of copper. The exterior of the tube 112 may include a porous layer that may serve as an insulator. The porous layer may correspond to a commercially available coating.

The material for the tube 112 may be selected to be different from that of the tubes 110 or the structure of the HX 106 in order to provide for a large, measurable (galvanic) potential difference. When the HX 106 is subject to corrosion, a signal may be measured or detected. For example, a measurable output voltage in an amount greater than a threshold may exist between the tube 112 and the tube 110 or the structure of the HX 106. Similarly, when the HX 106 is not subject to corrosion, the measured output voltage signal may be less than the threshold.

A computing device 118 is shown in FIG. 1. The computing device 118 may couple the tube 112 and one or more of the tubes 110. The computing device 118 may perform measurements and log data as described further below. While shown in FIG. 1 as being included with the HX 106, in some embodiments the computing device 118 may reside separately from the HX 106.

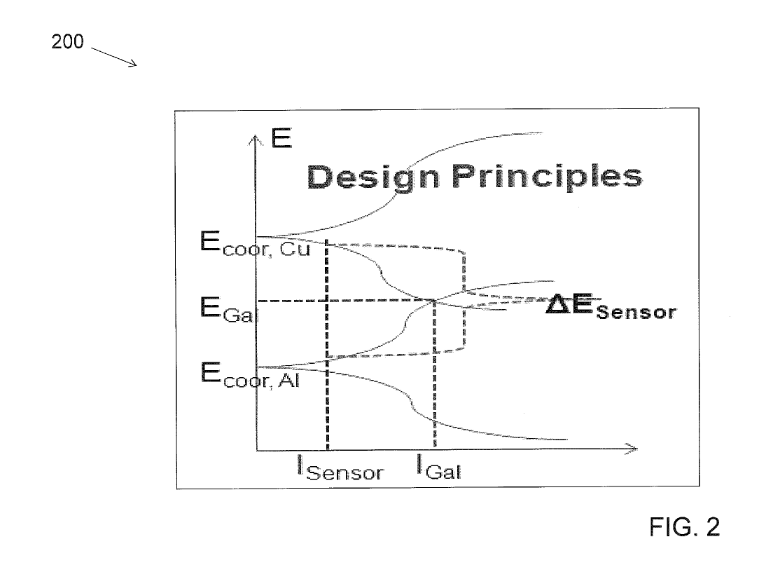

Referring to FIG. 2, a chart 200 is shown. The chart 200 plots voltage or potential on the vertical axis versus current on the horizontal axis. On the vertical axis, three points of potential are shown. A first point, denoted as E_{coor,Cu}, corresponds to a corrosion potential of copper. A second point, denoted as E_{Gal}, corresponds to a galvanic potential. The third point, denoted as E_{coor,Al}, corresponds to the a corrosion potential of aluminum. Similarly, on the horizontal axis, two points of current are shown. A first point, denoted as I_{Gal}, corresponds to a current at the galvanic potential E_{Gal}. A second point, denoted as ISensor, corresponds to a current associated with the sensor established by the use of the two different materials (copper and aluminum in this example).

If the different materials (e.g., copper and aluminum) were placed in direct contact with one another, a short circuit would develop and no potential difference would exist between the materials. This would render the measurement of E_{Gal} difficult. However, as described above in connection with FIG. 1, if a porous layer or material is used between the different materials, the porous material may serve as an insulator allowing a potential difference to be established and measured. This potential difference is denoted in FIG. 2 as ΔEₛₑₙₛₒᵣ. The measurement associated with ΔEₛₑₙₛₒᵣ can be analogized to measuring an output voltage of a battery.

While the example described above in connection with FIG. 2 related to voltage, one skilled in the art would appreciate that other parameters (e.g., current, power, energy, etc.) could be measured or monitored for purposes of sensing or detecting corrosion.

Referring back to FIG. 1, the effectiveness of the sensor created via the tubing 112 and porous layer may be analyzed by placing the sensor, or at least a portion of the HX 106, in a corrosion chamber as a specimen. The corrosion chamber may apply a salted solution to the specimen. The corrosion chamber may continuously apply the salted solution in a continuously-wet mode of operation. Alternatively, the corrosion chamber may alternate between not applying and applying the salted solution in what may be referred to as dry and wet cycles of operation, respectively. A corrosion chamber that operates using dry and wet cycles may be referred to as a cyclic corrosion chamber.

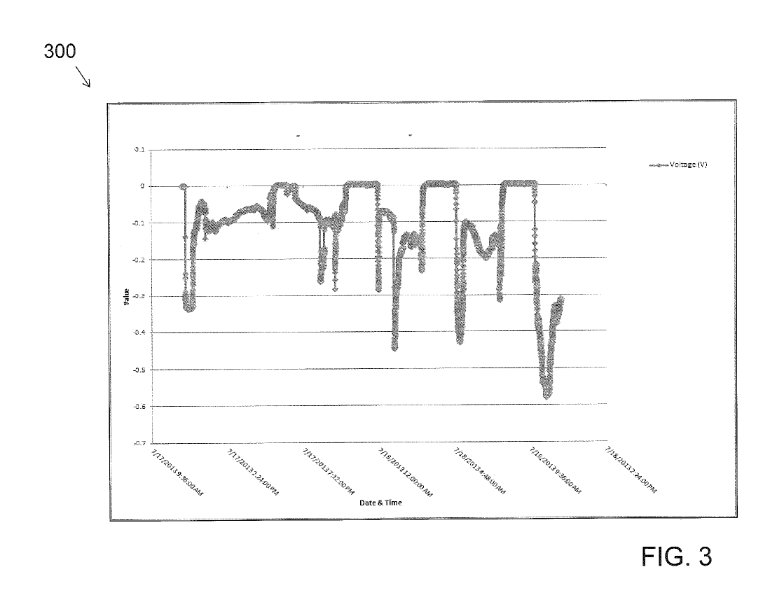

Referring to FIG. 3, a plot 300 of voltage on the vertical axis versus time on the horizontal axis for an exemplary specimen inserted into a cyclic corrosion chamber is shown. Points in time corresponding to when the voltage is equal to, or approximately equal to, zero may correspond to the dry cycles of operation. Similarly, large values in terms of the magnitude of the voltage may correspond to the wet cycles of operation.

In some instances, such as when the sensor or FIX 106 has been deployed in the field, it may be desirable to obtain an understanding of the environment in which the HX 106 was operating. In order to make such a determination, the sensor (or a portion thereof) may be placed in de-ionized water. Placement in the water may serve to extract any chemicals on the surface of the sensor to the water. Thereafter, a chemical analysis may be performed on the water to characterize the environment in which the sensor/HX 106 was located.

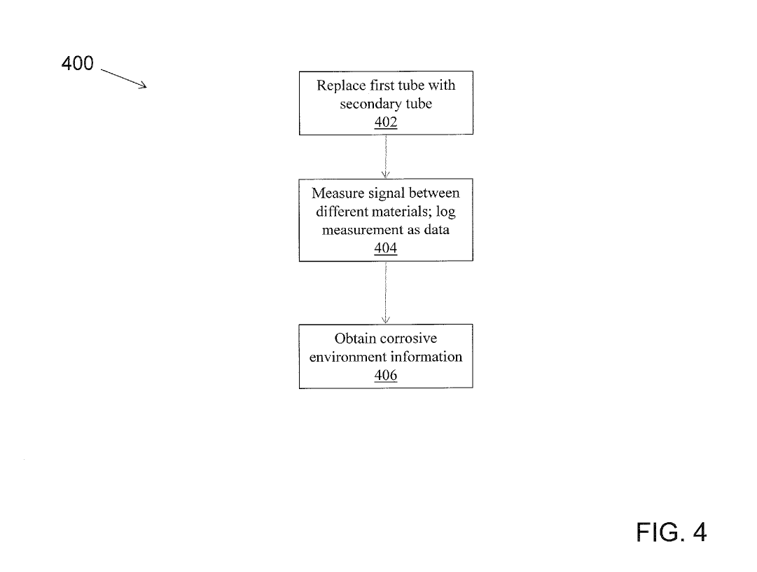

Turning now to FIG. 4, a flow chart of a method 400 is shown. The method 400 may be operative in connection with one or more environments, systems, devices, or components, such as those described herein. The method 400 may be used to design and use a corrosion sensor for a HX.

In block 402, a first tube associated with a HX may be replaced by, or substituted with, a secondary tube. In this respect, the secondary tube may be installed on the HX. The secondary tube may be made of a material that is different from the first tube or other tubes of the HX. For example, the secondary tube may be made of copper, whereas the first tube or the other tubes may be made of aluminum.

In block 404, a measurement of a signal, such as a galvanic voltage or current differential between the two different materials or metals may be made. The measurement of the signal may be logged as data using a computing or logging device, such as a Volta data logger or a zero-resistance ammeter. In some embodiments, the measured signal may be converted to digital data for storage using an analog-to-digital converter.

In block 406, corrosive environment information associated with the HX may be obtained based on the logged data of block 404.

In some embodiments, one or more of the blocks or operations (or a portion thereof) of the method 400 may be optional. In some embodiments, the blocks may execute in an order or sequence different from what is shown in FIG. 4. In some embodiments, one or more additional blocks or operations not shown may be included.

Embodiments of the disclosure may utilize different data points or data sets associated with a sensor to detect and characterize a degree of corrosion associated with a HX. For example, embodiments the disclosure may be used to efficiently, cheaply, and accurately determine a threat of leakage that a coil of a HX is subjected to. Embodiments of the disclosure may be implemented in a cost-effective manner while being specific to HX coils and while providing an ability to detect a corrosion condition at a location of concern, e.g., a tube surface. Aspects of the disclosure may be used to assure product safety and availability.

Aspects of the disclosure may be applied in connection with one or more applications, such as HVAC applications, refrigeration applications, aerospace applications, automobile applications, military applications, etc.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
installing a first tube made of a first material on a heat exchanger that is different from a second material associated with a second tube of the heat exchanger, wherein the first tube is coupled to the second tube via a porous layer associated with the first tube;
measuring a signal between the first tube and the second tube;
logging the measured signal as data; and
obtaining information associated with a corrosiveness of an environment in which the heat exchanger is located based on the data.

2. The method of claim 1, wherein the first tube is made of copper, and wherein the second tube is made of aluminum.

3. The method of claim 1, wherein the measured signal comprises a voltage.

4. The method of claim 1, wherein the measured signal comprises a current.

5. The method of claim 1, further comprising:
applying the measured signal to an analog-to-digital converter to obtain the data.

6. The method of claim 1, wherein the first tube coupled to the second tube via the porous layer forms a sensor, the method further comprising:
applying a salted solution to the sensor via a corrosion chamber,
wherein the measurement of the signal occurs when the sensor is in the corrosion chamber.

7. The method of claim 6, wherein the corrosion chamber is a cyclic corrosion chamber.

8. The method of claim 1, wherein the first tube coupled to the second tube via the porous layer forms a sensor, the method further comprising:
placing the sensor in de-ionized water to extract one or more chemicals on the surface of the sensor to the water; and
performing a chemical analysis on the water,
wherein the information associated with the corrosiveness of the environment in which the heat exchanger is located is based on the chemical analysis.

9. A corrosion sensor, comprising:
a first tube made of a first material;
a second tube made of a second material that is different from the first material; and
a porous layer associated with the first tube configured to couple the first tube and the second tube.

10. The sensor of claim 9, wherein the first tube is made of copper, and wherein the second tube is made of aluminum.

11. The sensor of claim 9, wherein the sensor is installed on a heat exchanger.

12. The sensor of claim 9, wherein the sensor is configured to enable a plurality of measurements to be taken between the first tube and the second tube in order to obtain information associated with a corrosiveness of an environment in which the sensor is located.

13. The sensor of claim 12, wherein the sensor is configured to enable a measurement of galvanic voltage to be taken.

14. The sensor of claim 12, wherein the sensor is configured to enable a measurement of differential current.

15. The sensor of claim 12, wherein the sensor is located in a corrosion chamber when the measurement is taken.

16. The sensor of claim 12, wherein the corrosion chamber is a cyclic corrosion chamber, and wherein the sensor is configured to enable the measurements to be taken during wet and dry cycles of the corrosion chamber.

17. The sensor of claim 9, wherein the sensor is located in de-ionized water to enable information associated with a corrosiveness of an environment in which the sensor is located to be determined.
